(19) United States
(12) Patent Application Publication
(10) Pub. No.: US 2006/0185859 A1
(43) Pub. Date: Aug. 24, 2006

(54) Portable fire extinguisher nozzle

(76) Inventor: Chen-Chun Lin, Taipei City (TW)

Correspondence Address: LEONG C LEI, PMB # 1008, 1867 YGNACIO VALLEY ROAD, WALNUT CREEK, CA, 94598, US

(21) Appl. No.: 11/060,418

(22) Filed: Feb. 18, 2005

(51) Int. Cl. A62C 31/02

(52) U.S. Cl. 169/74; 169/30; 239/288

(57) ABSTRACT

A portable fire-extinguisher nozzle includes a trumpet shaped holder with a internally threaded tail and a hollow shaft with its head disposed with multiple ejection holes; multiple slots corresponding to those ejection holes being provided on the inner edge of the head of the shaft; the shaft having a threaded tail to be locked to the tail of the holder; and further to the fire extinguisher for delivering well-distributed fire-extinguishing chemicals without causing disturbance to sprinkle to the fire for improved fire extinguishing result.

### BACKGROUND OF THE INVENTION

(a) Technical Field of the Invention

The present invention is related to a portable fire extinguisher nozzle, and more particularly, to one that applicable for foam, chemical powders, and liquid chemicals to achieve well distributed sprinkling for improved fire extinguishing result.

(b) Description of the Prior Art

As shown in FIG. 1 of the accompanying drawings, a portable fire extinguisher 1 of the prior art is adapted with a nozzle 11, a lever 13, and a handle 12 on top of a tank. In case of a fire, the lever 13 above the handle 12 is pressed to sprinkle fire- extinguishing chemicals stored in the tank to attempt putting out the fire. The nozzle 11 has a hollow body with a threaded end 111 to be locked to the top of the tank. The nozzle 11 is applicable for foam and chemical powders but not applicable to liquid fire-extinguishing chemicals. Furthermore, the result of putting out the fire is frustrated due to disturbance created in the course of sprinkling since there is only one ejection hole provided to the nozzle.

### SUMMARY OF THE INVENTION

The primary purpose of the present invention is to provide a portable fire-extinguisher nozzle that improves the fire extinguishing result by preventing disturbance in the course of sprinkling and is applicable to various types of foams, chemical powders and liquid fire-extinguishing chemicals.

To achieve the purpose, the nozzle is comprised of a holder and a hollow shaft. Wherein, the holder is made in a trumpet shape and has inner edge at its rear threaded. Multiple ejection holes are arranged surrounding to front of the shaft and the inner edge of the front of the shaft is disposed with multiple slots corresponding to those ejection holes. The rear of the shaft is threaded for the shaft to be locked to the rear of the holder to form the nozzle. The nozzle is then locked to the fire extinguisher.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the prior art adapted to a portable fire extinguisher.

FIG. 2 is an exploded view of a preferred embodiment of the present invention adapted to a portable fire extinguisher.

FIG. 3 is a perspective view of the preferred embodiment of the present invention adapted to a portable fire extinguisher.

FIG. 4 is a schematic view showing a construction of multiple slots of the nozzle of the present invention.

FIG. 5 is a sectional view showing the preferred embodiment of the present invention.

FIG. 6 is a schematic view showing that the preferred embodiment of the present invention is in use.

FIG. 7 is another schematic view showing that the preferred embodiment of the present invention is in use.

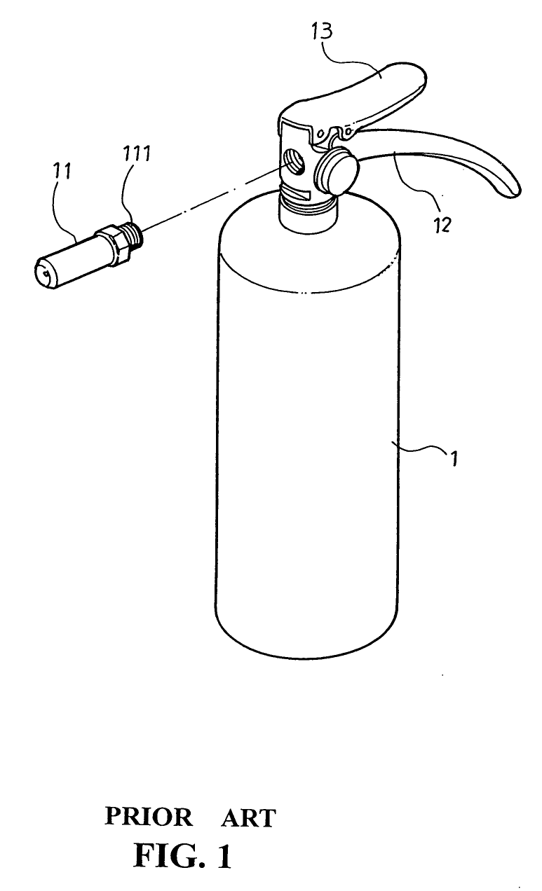

### DETAILED DESCRIPTON OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

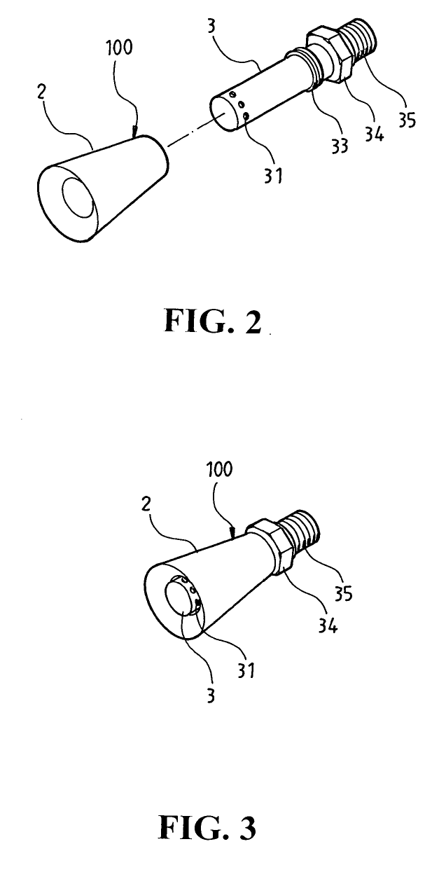

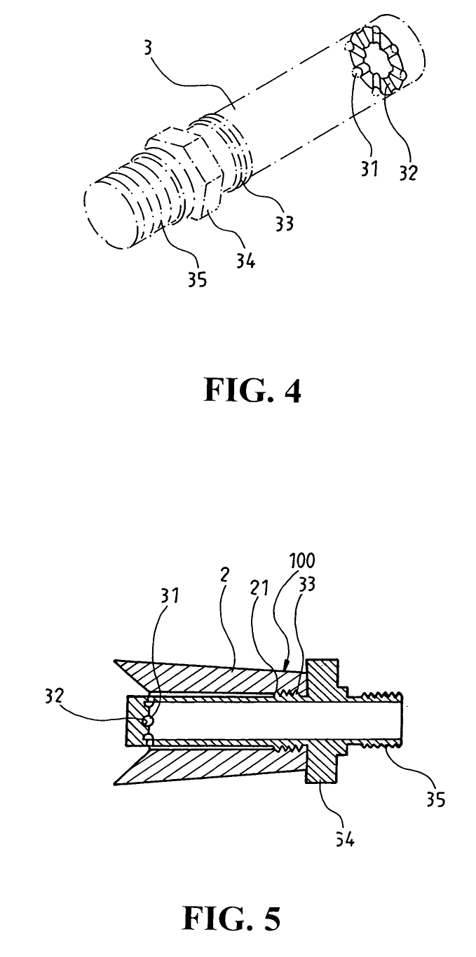

Referring to FIGS. 2 through 5, a preferred embodiment of the present invention is essentially comprised of a hollow holder 2 and a hollow shaft 3. Wherein, the holder 2 is made in a shape of a trumpet and a threaded inner edge 21 in the rear of the holder 2.

Multiple ejection holes 31 are arranged surrounding the head the hollow shaft 3 and multiple slots 32 arranged longitudinally on the inner edge of the head of the shaft 3 in corresponding to those ejection holes 31. The shaft 3 has a threaded tail 33 and a coupler 34 extends from the threaded end 33. The coupler 34 has a threaded tail 35.

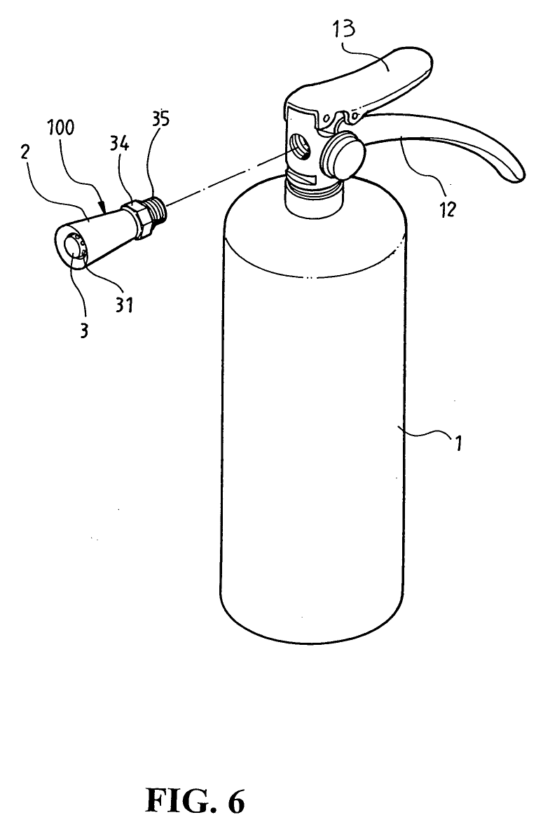

The shaft 3 is locked with its threaded tail 33 to the holder 2 leaving the head of the shaft 3 to be exposed out of an opening provided at the tip of the holder 2 to form a nozzle 100. The nozzle 100 is then locked to the fire extinguisher 1 by means of the threaded tail 35 of the coupler 34 as illustrated in FIG. 6. In case of a fire, fire-extinguishing chemicals 4 contained inside the tank of the fire extinguisher are directed to the fire and sprinkled through the shaft 3. Fire-extinguishing chemicals are delivered evenly without causing disturbance to improve fire-extinguishing result.

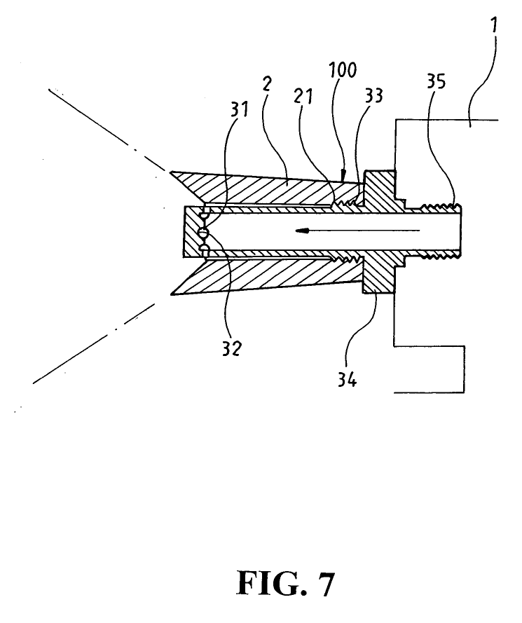

Now referring to FIG. 7, those fire-extinguishing chemicals 4 in the tank of the fire extinguisher pass through the shaft 3 and sprinkle out of those ejection holes 31 provided at the head of the shaft 3. Whereas those ejection holes 31 are arranged around the head of the shaft 3 and alternatively provided with those multiple slots 32, those fire-extinguishing chemicals 4 are first delivered laterally and then sprinkle out of the head of the holder 2 in an internally inclined sector without causing any disturbance to secure well distributed sprinkle for improving fire-extinguishing result. With the fire-extinguishing chemicals 4 guided by those multiple ejection holes and slots 32, the nozzle 100 is applicable to the portable fire extinguisher containing foam, chemical powders, or liquid fire-extinguishing chemicals.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A nozzle for a portable fire-extinguisher includes a hollow holder, having an internally threaded tail; and a hollow shaft, having multiple ejection holes surrounding its head, multiple slots corresponding to those ejection holes being longitudinally disposed on the inner edge of its head, and a threaded tail; the shaft being locked to the holder; the front of the shaft being exposed out of an opening provided on the head of the holder to deliver fire-extinguishing chemicals well-distributed in an internally inclined sector without causing disturbance for improved fire-extinguishing result.
